(19) United States
(12) Patent Application Publication
(10) Pub. No.: US 2003/0177300 A1
(43) Pub. Date: Sep. 18, 2003

(54) Data processing method in high-capacity flash EEPROM card system

(75) Inventors: Yeon Cheol Lee, Suwon-Shi (KR); Jong Sik Jeong, Seoul (KR)

Correspondence Address: DARBY & DARBY P.C., 805 Third Avenue, New York, NY, 10022, US

(73) Assignee: SAMSUNG ELECTRO-MECHANICS CO., LTD., Suwon-Shi (KR)

(21) Appl. No.: 10/236,644

(22) Filed: Sep. 6, 2002

(30) Foreign Application Priority Data
Mar. 18, 2002 (KR) 2002-14532

(51) Int. Cl. G06F 12/00

(52) U.S. Cl. 711/103; 711/173; 711/207

(57) ABSTRACT

Disclosed is a data process method in a high-capacity flash erasable and programmable read-only memory (EEPROM) card system mounted with at least one flash EEPROM and a controller connected to a host computer, having an interface for down/up loading arbitrary data into the flash EEPROM data regions to access the host computer, the method including: a first procedure for setting a designated number of block regions that divide the flash EEPROM data regions into a designated arbitrary size and for sub-dividing each block region to a designated number of mapping table regions; and a second procedure for providing the flash EEPROM data regions to access the host computer with the sub-divided mapping table region unit on the basis of a look-up-table in a volatile memory region inside of the controller. The present invention is very effective for the high-capacity flash EEPROM that usually requires a large number of blocks because it enables to operate a number of blocks on the volatile memory with the limited capacity even when the number of blocks exceeds the volatile memory capacity.

### BACKGROUND OF THE INVENTION

1. Field of the Invention

The present invention generally relates to a system using flash EEPROM (electrically erasable and programmable read-only memory) for storages like computers and digital cameras. In particular, the present invention relates to a data processing method in high-capacity flash EEPROM for dividing and operating a look-up-table which processes flash EEPROM blocks having an access to data files in an auxiliary storage device using flash EEPROM with limited volatile memory capacities, especially in case the look-up-table exceeds the volatile memory.

2. Description of the Related Art

Currently, flash EEPROM is drawing a lot of attentions as a substitute semiconductor memory for magnetic disks like hard disks or floppy disks. The flash EEPROM is non-volatile, low power consumption semiconductor memory, and can be electrically programmed. Since the memories are small, light and strong against vibration, they are widely applicable to portable devices.

In general, the flash EEPROM described above is used for a flash EEPROM card. The typical flash EEPROM card is mounted with one or more flash EEPROM (IC chip). Normally, the card is provided to a PC card compatible with personal computer memory card international association (PCMCIA).

Particularly, the PCMCIA specification requires the PC card to have card attribute information called card information structure (CIS) for displaying or describing the configuration or access method of the card. It is so because compatibility of the card between host computers (such as, personal computers) complying with the standard needs to be improved.

This type of flash EEFROM card is mounted with flash EEFROM, a controller connected to a host system through a designated interface for operating data reading/recording on the flash EEPPOM on the card, read only memory (ROM) having programs necessary for the operation of the controller, and random access memory (RAM) having data.

Normally, the known flash EEPROM card stores the CIS information plus other kinds of software programs in the ROM. When the flash EEPROM is inserted in a card slot of a host system, the host computer searches the CIS information on the flash EEFROM card.

At this time, the controller housed in the flash EEPROM card reads CIS information from the ROM, and stores the information in the RAM where the host computer is able to access directly or in a register. The host computer, based on the CIS information loaded from the flash EEPROM card, assigns memory space, input/output (I/O) space region, interrupt level and so forth to the card, and later makes read/record access to flash EEPROM on the card in sequence.

More specifically, the host system is sent to an auxiliary memory unit in the form of cylinder, head and sector (CHS), and the controller housed in the auxiliary memory unit converts the cylinder, head and sector to logical block address (hereinafter, it is referred to LBA). Then, the controller changes the LBA to physical block address (hereinafter, it is referred to PBA), and finally this address is used to access data files in the flash EEPROM.

Therefore, a data file changes whenever there is a change therein. And, the changed data files are stored in a new PBA without data (i.e., it has not been used or is empty having the stored data all erased) in the flash EEPROM. The erase operation is carried out primarily because the physical block that is already erased but usable in the flash EEPROM should exist for the changed data files. The erase operation usually erases old physical blocks having data files before the change.

Such procedure often causes the PBA corresponding to the LBA to be changed. In other words, the compatible association between the LB and the PB is changed. The information regarding the association exists in a volatile memory particularly as a look-up-table, and the controller updates the look-up-table every time the association changes.

Also, it is important to keep the information on this updated table. The controller manages dynamically changing look-up-table, and in consequence, this managing procedure operates the block inside of the flash EEPROM. Especially, as for the apparatus using the flash EEPROM as an auxiliary memory unit, the volatile EEPROM and the controller are all built-in system, and are mostly integrated in a semiconductor. For such reasons, their sizes were inevitably limited.

Therefore, the high-capacity auxiliary memory unit using flash EEPROM was problematic in that to operate the block of the flash EEPROM, the look-up-table in the volatile memory could always exceed the maximum capacity of the volatile memory.

The problem became more apparent nowadays for the number of blocks to be processed at a micro controller is increased, as the capacity of flash EEPROM got higher. This means that when the volatile memory with limited capacity is used, the number of blocks to be processed sometimes exceeds the maximum capacity. In such case, data processing in a practical manner becomes very difficult and unfortunately errors occur therefrom.

### SUMMARY OF THE INVENTION

It is, therefore, an object of the present invention to provide a data processing method in a high-capacity flash EEPROM (electrically erasable and programmable read-only memory) card system for storages like computers and digital cameras, in which a look-up-table which processes flash EEPROM blocks having an access to data files in an auxiliary storage device using flash EEPROM with limited volatile memory capacities is divided and operated, especially in case the look-up-table exceeds the volatile memory.

To achieve the above object, there is provided a data processing method in a high-capacity flash EEPROM card system mounted with at least one flash EEPROM and a controller connected to a host computer, having an interface for down/up loading arbitrary data into the flash EEPROM data regions to access the host computer, the method including: a first procedure for setting a designated number of block regions that divide the flash EEPROM data regions into a designated arbitrary size and for sub-dividing each block region to a designated number of mapping table regions; and a second procedure for providing the flash EEPROM data regions to access the host computer in the sub-divided mapping table region unit on the basis of a look-up-table stored in the “Queue” block, the physical block and the reserved block in a volatile EEPROM region inside of the controller.

Another aspect of the present invention provides a data processing method in a high-capacity flash EEPROM card system mounted with at least one flash EEPROM and a controller connected to a host computer, having an interface for down/up loading arbitrary data into the flash EEPROM data regions to access the host computer, in which a data writing operation method in the flash EEPROM system for setting a designated number of block regions that divide the flash EEPROM data regions into a designated arbitrary size and for sub-dividing each block region to a designated number of mapping table regions includes: a first procedure for transmitting CHS (Cylinder, Head, and Sector)value to let the host access data files in the flash EEPROM; a second procedure for generating logical block address (LBA) on the basis of the transmitted CHS from the first procedure and for deciding whether or not the generated LBA's range exceeds full capacity of the flash EEPROM; a third procedure for storing the data transmitted from the host in volatile memory inside of the controller and for converting the stored data to physical block address (PBA); a fourth procedure for obtaining an index number of the mapping table region based on the PBA and for comparing the index number with a previous index number; a fifth procedure for storing a current look-up-table in the flash EEPROM, if the new index number obtained in the fourth procedure is not identical with the previous index number, loading a look-up-table corresponding to the new index number from the flash EEPROM, and for changing the new index number back to the previous index number; and a sixth procedure for obtaining a new PBA for use of the flash EEPROM from “Queue” block table of the volatile EEPROM inside of the controller, writing data from a data buffer inside of the volatile EEPROM on a corresponding mapping table region of a relevant flash EEPROM on the basis of the new PBA, and for updating the look-up-table.

Still another aspect of the present invention provides a data processing method in a high-capacity flash EEPROM card system mounted with at least one flash EEPROM and a controller connected to a host computer, having an interface for down/up loading arbitrary data into the flash EEPROM data regions to access the host computer, in which a data reading operation method in the flash EEPROM system for setting a designated number of block regions that divide the flash EEPROM data regions into a designated arbitrary size and for sub-dividing each block region to a designated number of mapping table regions includes: a first procedure for transmitting CHS (Cylinder, Head, Sector)value to let the host access data files in the flash EEPROM; a second procedure for generating logical block address (LBA) on the basis of the transmitted CHS from the first procedure and for deciding whether or not the generated LBA's range exceeds full capacity of the flash EEPROM; a third procedure for storing the data transmitted from the host in volatile memory inside of the controller and for converting the stored data to physical block address (PBA); a fourth procedure for obtaining an index number of the mapping table region based on the PBA and for comparing the index number with a previous index number; a fifth procedure for storing a current look-up-table in the flash EEPROM, if the new index number obtained in the fourth procedure is not identical with the previous index number, loading a look-up-table corresponding to the new index number from the flash EEPROM, and for changing the new index number back to the previous index number; and a sixth procedure for transmitting data corresponding to the loaded look-up-table in the fifth procedure to the host side.

### BRIEF DESCRIPTION OF THE DRAWINGS

The above objects, features and advantages of the present invention will become more apparent from the following detailed description when taken in conjunction with the accompanying drawings, in which:

FIG. 1 is an exemplary diagram of a typical circuit configuration of a flash EEPROM card;

FIG. 2 is a block diagram illustrating functional configuration of a controller with the reference numeral 10 in FIG. 1;

FIG. 3 is an exemplary diagram of a storage region's format in each flash EEPROM FMi (i=0˜n);

FIG. 4 is an exemplary diagram of a system explaining a data processing method in accordance with the prior art;

FIG. 5 is an exemplary diagram of a system explaining a data processing method in accordance with the present invention;

FIG. 6 is a flow chart of a writing operation in accordance with a preferred embodiment of the present invention;

FIG. 7 is a flow chart of a reading operation in accordance with another preferred embodiment of the present invention; and

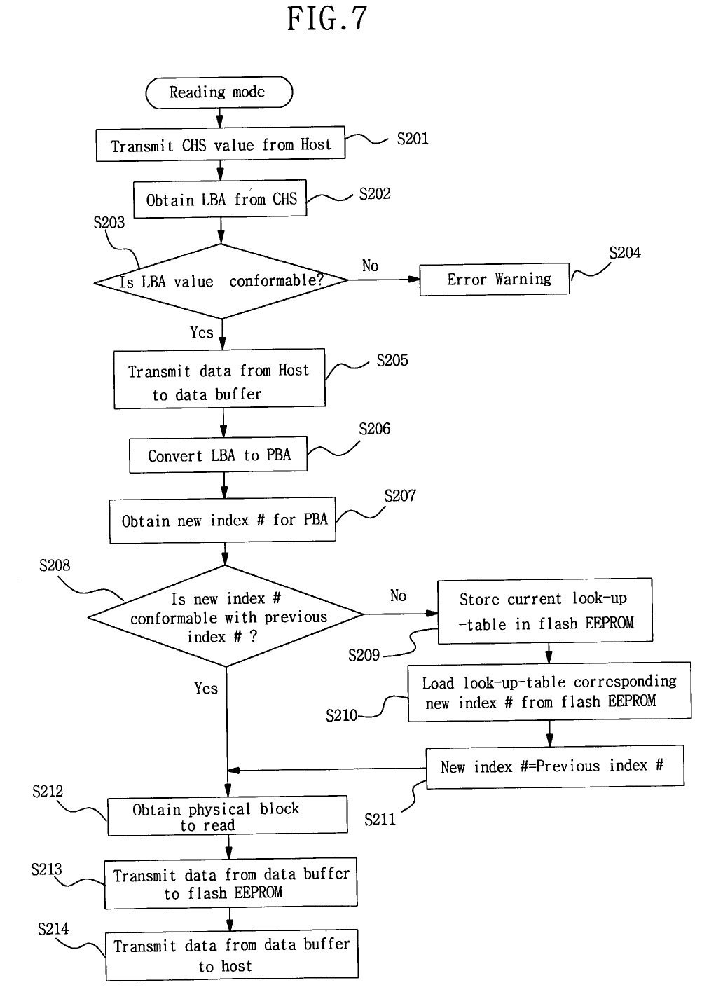

FIG. 8 is a schematic diagram of a look-up-table housed in a volatile memory.

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

First of all, a known flash electrically erasable and programmable read-only memory (EEPROM) card applied to the present invention and technology of its usage system are explained below.

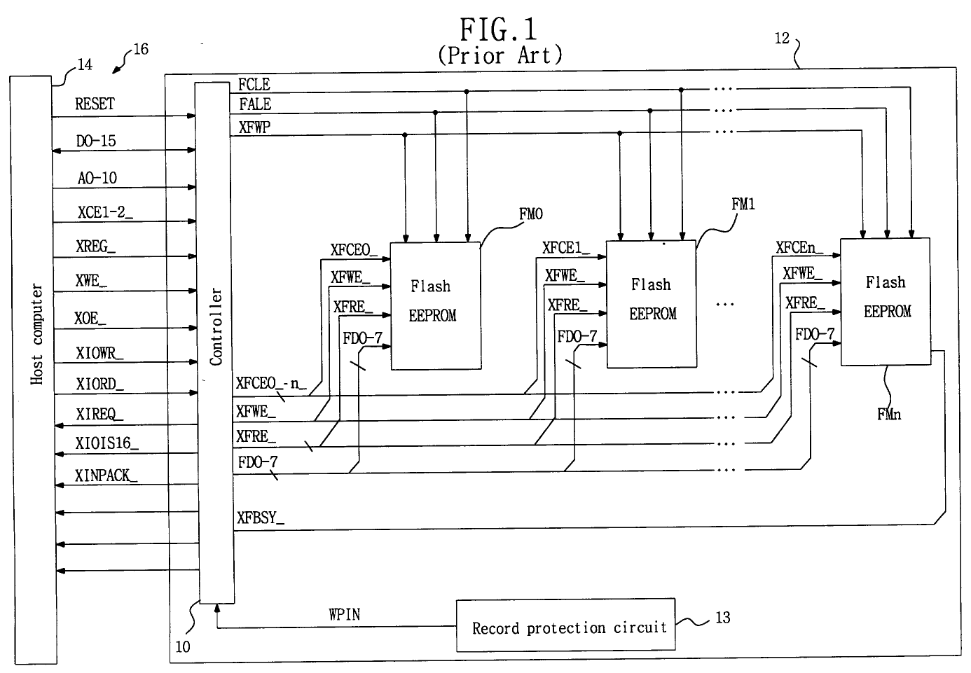

FIG. 1 enclosed herewith is a diagram illustrating a typical circuit configuration of the flash EEPROM. As depicted in the drawing, the flash EEPROM includes a one-chip controller 10, a plurality of (n+1) NAND flash EEPROM FM0 through FMn, and a record protection circuit 13 mounted on a card plate 12.

When the card plate 12 is inserted to a card slot of a host computer 14, the controller 10 is connected to the host computer 14 through a matching interface with a designated specification, for example, personal computer memory card international association-AT attachment (PCMCIA-ATA) or integrated drive electronics (IDE) interface 16. The flash EEPROM FM0 through FMn is composed of memory chips having the same array and feature.

To every flash EEPROM FM0 through FMn, the controller 10 is connected through 8-bit internal buses FD0 through FD7, control lines that are common in all flash EEPROM FM0 through FMn (i.e., FCLE, FALE, XFWP, XFWE-, XFRE-, and XFBSY-), and n+1 (it is the same number with the total flash EEPROM FM0 through FMn) individual control line XFCE0 through XFCEn. Especially, the internal buses FD0 through FD7 are used for transmitting command, address, and data between the controller 10 and the flash EEPROM FM0 through FMn.

To be more specific on the common control lines, the control line FCLE is a command latch enable control line for identifying a command code on the flash EEPROM FM0 through FMn as a command. The control line FALE is an address latch enable control line for identifying an address code on the flash EEPROM FM0 through FMn as an address. The control line XFWP is a record protection control line for forcefully inhibiting a record operation of the flash EEPROM FM0 through FMn. The control line XFWE- is a record enable control line for letting each flash EEPROM FM0 through FMn receive a code or data on the buses FD0 through FD7. The control line XFRE- is a read (output) enable control line for outputting data read from each output port of the flash EEPROM FM0 through FMn to the buses FD0 through FD7. Lastly, the control line XFBSY- is a busy line for informing the controller 10 that the flash EEPROM FM0 through FMn are currently using the buses FM0 through FM7.

Each control line XFCE0- through XFCEn- acts as a chip enable control line for setting each flash EEPROM FM0 through FMn separately or independently in a chip enable state (that is, in an operable state).

A record protection circuit 13, although its detail will be followed later, provides a record protection signal, “WPIN”, in accordance with a passive switch operation mounted on the card. Once the record protection signal, “WPIN”, provided from the record protection circuit 13 is set in an active state (H-state, or high state), the controller 10 is set to a record protection mode, and rejects any record request from the host computer.

The controller 10 includes a hardware CPU, ROM, RAM, and an input/output interface circuit.

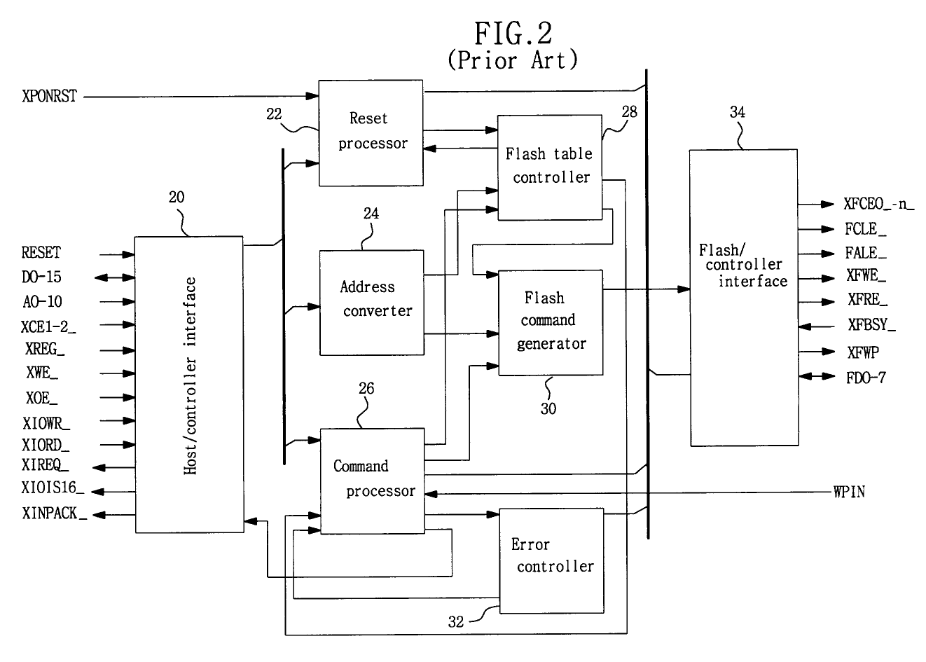

FIG. 2 is a block diagram illustrating a functional configuration of the controller with the reference numeral 10 in FIG. 1.

In terms of function, the controller 10 includes a host/controller interface 20, a reset processor 22, an address converter 24, a command processor 26, a flash table controller 28, a flash command generator 30, an error controller 32 and a flash/controller interface 34.

Specifically speaking, the host/controller interface 20 is connected to a variety of memories or registers the host computer 14 directly records/reads data, and is accessed to the host computer's bus through an interface matching with a designated specification, for instance, the PCMCIA-ATA interface. The changed CIS information inbetween the host computer 14 and the controller 10 is temporarily stored in the memory or register housed in the host/control interface 20.

Such interface enables the host computer 14 to select each register in the host/controller interface 20 using the address signals A0 through A10 and the control signals XCE1- through XCE2-.

At this time, the first control signal XREG- is used for selecting EEPROM space and input/output (I/O) space of an address map. The second control signal XWE-/XOE- is used for recording or reading data in or from the EEPROM space. The third control signal XIOWR-/WIORD- is used for recording or reading data in or from the I/O space.

The host/control interface 20 outputs an interrupt request XIREQ- or input acknowledge signal XINPACK to the host computer 14. Also, the host/control interface 20 includes a circuit for decoding a command from the host computer 14.

The reset processor 22 controls reset operations for each component of the controller 10 or initialization operations following the reset release operation, in response to the external reset signal, for example, the reset signal XPONRST.

The address converter 24 converts a logic address in the CHS (Cylinder Head Sector) mode of the host computer 14 to a logic address of LBA of the flash EEPROM card.

The command processor 26 controls each component of the controller 10, and executes the command that has been provided by the host computer 20 and decoded by the host/control interface 20.

The flash table controller 28, in response to the request from the reset processor 22 or the command processor 26, initializes an address conversion table and an empty block table, and searches or updates the table complying with the command from the host computer 14. Generally, the flash table controller 28 contains a static random access memory (SRAM) manufactured table EEPROM. According to this table EEPROM, the address conversion table and the empty block table are formed.

The flash command generator 30 generates a command code and an address signal for the flash EEPROM FM0 through FMn at the request of the flash table controller 28 or the command processor 26.

The error controller 32 generates an error correcting code (ECC) during the record operation, and executes ECC error control during the read operation. In addition, the error controller 32 performs a block replacement process especially when there is a failure or error therein.

The flash/control interface 34 is an input/output port for exchanging each flash EEPROM FM0 through FMn, data and signal through the command buses FD0 through FD7 and the variety of control lines (such as, the control lines FCLE and FALE). Further, the flash/control interface 34 is equipped with a timing control function for multiplexing the command, address and data on the common buses FD0 through FD7 into different timings.

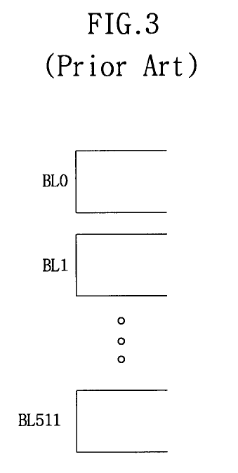

FIG. 3 illustrates a format of a storage region in each flash EEPROM FMi (i=0˜n).

To summarize the EEPROM operation method in a system using the conventional flash EEPROM having the same configuration in FIG. 3, the host system is sent to an auxiliary storage device in the form of cylinder, head, and sector (CHS), and the controller housed in the auxiliary storage device converts the cylinder, head, and sector (CHS) to a logical block address (LBA). Then, the controller changes the LBA to a physical block address (PBA), and uses this address at the end to access data files in the flash EEPROM.

Therefore, a data file changes whenever there is a change therein. And, the changed data files are stored in a new PBA without data (i.e., it has not been used or is empty having the stored data all erased) in the flash EEPROM. The erase operation is carried out primarily because the physical block that is already erased but usable in the flash EEPROM should exist for the changed data files. The erase operation usually erases old physical blocks having data files before the change.

Such procedure often causes the PBA corresponding to the LBA to be changed. In other words, the compatible association between the LB and the PB is changed. The information regarding the association exists in a volatile memory particularly as a look-up-table, and the controller updates the look-up-table every time the association changes.

Also, it is important to keep the information on this updated table. The controller manages dynamically changing look-up-table, and in consequence, this managing procedure operates the block inside of the flash EEPROM. Especially, as for the apparatus using the flash EEPROM as an auxiliary memory unit, the volatile EEPROM and the controller are all built-in system, and are mostly integrated in a semiconductor. For such reasons, their sizes were inevitably limited.

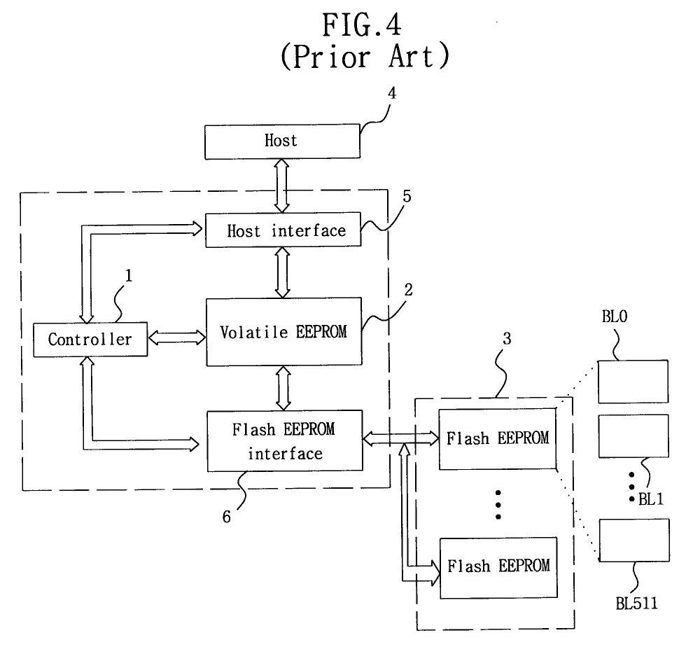

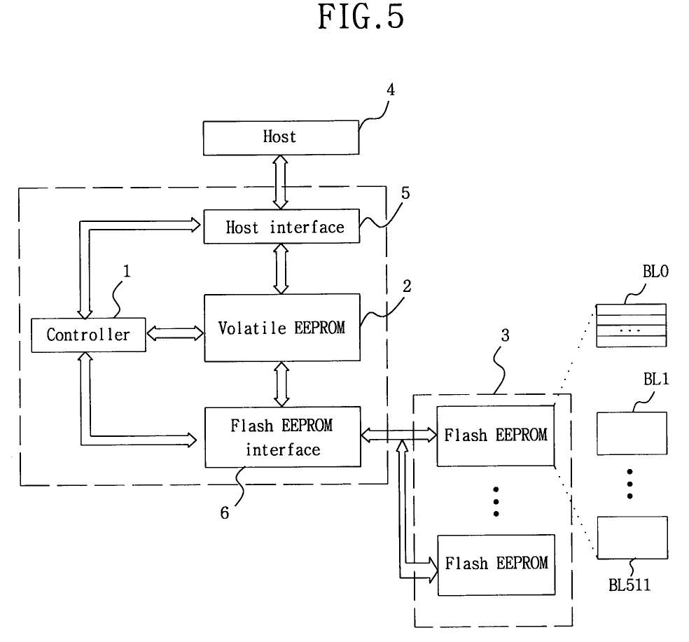

In short, the present invention, unlike the EEPROM operation method in the block unit as shown in FIG. 4 according to the prior art, operates the divided EEPROM in the sub-divided (or fragmented) block unit as depicted in FIG. 5.

Particularly, the block diagrams illustrated in FIGS. 4 and 5 show the entire configuration of the auxiliary storage device using the flash EEPROM according to the present invention. It should be noted that the present invention is not focusing on the hardware but on the processing method.

Besides, the configurations illustrated in FIGS. 4 and 5 roughly show the system illustrated in FIGS. 1 and 2. Taking from the configuration of the entire system, the host 4 can he a computer, digital camera, or personal digital assistant (PDA).

The rest of the blocks 1,2,3,5 and 6 except for the host 4 can be existed in a card format as one module. The host 4 can transfer every kind of command, read status information, and read/write data files through the host interface 5.

The controller 1 is capable of decoding and processing all kinds of commands transmitted through the host interface 5, and the volatile EEPROM 2 is used as a buffer for temporarily storing data when the host 1 reads or writes data using the flash EEPROM 3, and as a memory for storing every kind of variable for the controller 1 to process data. Moreover, the flash EEPROM 3 is a storage medium being used as an auxiliary storage device.

On the other hand, the controller 1 also processes commands and addresses that are sent to the host 4 in order to access data files in the flash EEPROM through the flash memory interface 6.

As shown in FIG. 4, the data reading and writing according to the prior art are accomplished through an access to the data regions inside of the flash EEPROM in the block unit. Meanwhile, the present invention subdivided the block unit composing the data regions inside of the flash EEPROM into a plurality of mapping tables, and tried to access each mapping table (M-Table#) for reading and writing data.

Therefore, such operations are performed by the controller (reference number 1).

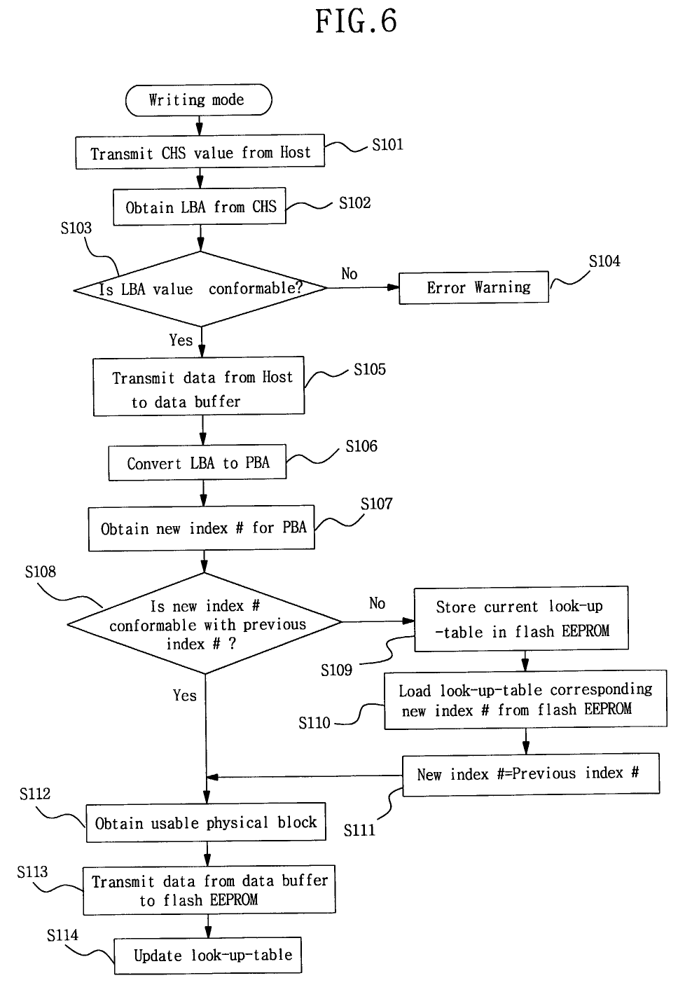

FIG. 6 is an operational flow chart illustrating a data writing operation of other data processing method in the mapping table (M-Table #) unit, which is a sub-divided block unit.

Again, the controller 1 conducts the operation.

As shown in FIG. 6, the host 4 transmits CHS (Cylinder, Head, and Sector) to access data files in the flash EEPROM 3 (S101).

The transmitted CHS is converted to logical block address (LBA) (S102), and it is decided whether the LBA value is suitable (or conformable)(S103).

That is to say, it is decided whether the LBA range exceeded total capacity of the flash EEPROM, and if so, it is reported to the host 4 and no further writing operation is executed (S104).

In contrast, if the LBA range did not exceed total capacity of the flash EEPROM, the transmitted data from the host 4 is first stored in the volatile EEPROM 2 for use of data buffer (S105).

Through the step 105, the LBA, that is, the data transmitted from the host 4, being stored in the volatile EEPROM 2 as a data buffer, is converted to a physical block address (PBA), the accessible form to the flash EEPROM.

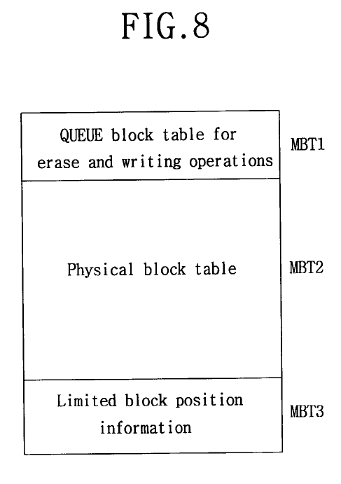

Specifically, the PBA is an individual block number of the entire blocks of the flash EEPROM in which data files inside of the flash EEPROM can be stored, and as shown in FIG. 8, it resides in a divided non-volatile flash EEPROM 3 in the form of array.

Later, the controller 1, based on the PBA, is reprocesses as an address (chip enable, block number of the flash EEPROM, page number) which the flash EEPROM 3 has an access physically through the flash EEPROM interface 6.

In the next step, an index number is obtained based on the PBA through the step 106 (S107). Here, the index number is the information indicating the number of divisions of the PBA. Particularly in the present invention, the PBA is subdivided to support the high-capacity auxiliary storage device.

Namely, it indicates the mapping table (reference numeral M-Table#), and the PBA of the entire flash EEPROM is divided into a certain number so it does not exceed the limited volatile EEPROM capacity.

In the meantime, the PBA of the rest of the indexes except for the one index loaded into the volatile EEPROM during the initialization process is put in the flash EEPROM.

Next, the index number obtained in the step 107 is examined to find out if it conforms with the index inside of the current volatile EEPROM 2 (S108). If so, it means that the PBA range obtained through the step 106 conforms with the PBA range inside of the current volatile EEPROM 2.

Therefore, there is no need to load other PBA ranges inside of the flash EEPROM 3.

However, if it turns out that the two PBA ranges do not conform with each other, the current look-up-table is stored in the flash EEPROM 3 (S109), and a look-up-table corresponding to a new index number is loaded from the flash EEPROM 3 (S110). Then, this new index number replaces the previous index number, and another PBA having the same range inside of the volatile EEPROM 2 is newly loaded from the flash EEPROM 3 (S111).

Afterwards, a PBA for use of the flash EEPROM 3 is obtained from the block table indicated as “Queue” (reference numeral MBT1 in FIG. 8) (S112).

The data in the data buffer inside of the volatile EEPROM 2 is written in a place of a corresponding flash EEPROM 3 on the basis of the PBA obtained through the step 111 (S113).

Lastly, the look-up-table is updated (S114). In other words, the block for performing the writing operation thereon in the step 112 depicted in FIG. 6 is obtained from a “Queue” for writing out of the “Queue” block table (reference numeral MBT1 in FIG. 8). The “Queue” has an array of first-in first-out (FIFO), and contains a usable PBA. The obtained PBA here becomes the actual flash EEPROM address for responding to commands from the host.

The PBA is assigned to a physical block table (reference numeral MBT2 in FIG. 8) because the look-up-table corresponding to the LBA of the host is also indicated as the reference numeral MBT2 in FIG. 8.

As noted before, before the PBA obtained from “Queue” for the writing operation is assigned to the MBT2 in FIG. 8, the original PBA in the MBT2 assigns the erase operation (reference numeral MBT1 in FIG. 8) to the “Queue”. The “Queue” having the FIFO array also includes the PBA to be erased. In this manner, the PBA is assigned to the “Queue” for writing the erased block.

As explained, the table of FIG. 8, considering the characteristics of the volatile EEPROM, is periodically stored in the reserved block region of the flash EEPROM. The reference numeral MBT3 in FIG. 8 has position information of the flash EEPROM of the look-up-table that is periodically stored in the reserved region of the flash EEPROM.

Similar to the writing operation, the reading operation is performed starting with the host 4, which transmits CHS to access data files in the flash EEPROM 3 (S201).

The transmitted CHS is converted to logical block address (LBA) (S202), and it is decided whether the LBA value is suitable (or conformable) (S203).

That is to say, it is decided whether the LBA range exceeded total capacity of the flash EEPROM, and if so, it is reported to the host 4 and no further writing operation is executed (S204).

In contrast, if the LBA range did not exceed total capacity of the flash EEPROM, the transmitted data from the host 4 is first stored in the volatile EEPROM 2 for use of data buffer (S205).

Through the step 205, the LBA, that is, the data transmitted from the host 4, being stored in the volatile EEPROM 2 as a data buffer, is converted to a physical block address (PBA), the accessible form to the flash EEPROM.

Specifically, the PBA is an individual block number of the entire blocks of the flash EEPROM in which data files inside of the flash EEPROM can be stored, and as shown in FIG. 8, it resides in a non-volatile flash EEPROM 3 in the form of array.

Later, the controller 1, based on the PBA, is reprocesses as an address (chip enable, block number of the flash EEPROM, page number) which the flash EEPROM 3 has an access physically through the flash EEPROM interface 6.

In the next step, an index number is obtained based on the PBA through the step 206 (S207). Here, the index number is the information indicating the number of divisions of the PBA. Particularly in the present invention, the PBA is subdivided to support the high-capacity auxiliary storage device.

Namely, it indicates the mapping table (reference numeral M-Table#), and the PBA of the entire flash EEPROM is divided into a certain number so it does not exceed the limited volatile EEPROM capacity.

In the meantime, the PBA of the rest of the indexes except for the one index loaded into the volatile EEPROM 2 during the initialization process is put in the flash EEPROM 3.

Next, the index number obtained in the step 207 is examined to find out if it conforms with the index inside of the current volatile EEPROM 2 (S208). If so, it means that the PBA range obtained through the step 206 conforms with the PBA range inside of the current volatile EEPROM 2.

Therefore, there is no need to load other PBA ranges inside of the flash EEPROM 2.

However, if it turns out that the two PBA ranges do not conform with each other, the current look-up-table is stored in the flash EEPROM 3 (S209), and a look-up-table corresponding to a new index number is loaded from the flash EEPROM 3 (S210). Then, this new index number replaces the previous index number, and another PBA having the same range inside of the volatile EEPROM 2 is newly loaded from the flash EEPROM 3 (S211).

One thing different from the writing operation is that the PBA for reading is not obtained from the “Queue” block table (MBT1 in FIG. 8), but from the physical block table (MBT2 in FIG. 8).

Therefore, the updating process on the look-up-table performed in the step 114 of FIG. 6 is not carried out here in the reading operation.

In conclusion, the data processing method in a high-capacity flash EEPROM card system according to the present invention is particularly effective for the high-capacity flash EEPROM that usually requires a large number of blocks because the present invention enables to operate a number of blocks on the volatile EEPROM with the limited capacity even when the number of blocks exceeds the volatile EEPROM capacity.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A data processing method in a high-capacity flash erasable and programmable read-only memory (EEPROM) card system mounted with at least one flash EEPROM and a controller connected to a host computer, having an interface for down/up loading arbitrary data into the flash EEPROM data regions to access the host computer, the method comprising:
a first procedure for setting a designated number of block regions that divide the flash EEPROM data regions into a designated arbitrary size and for sub-dividing each block region to a designated number of mapping table regions; and
a second procedure for providing the flash EEPROM data regions to access the host computer with the sub-divided mapping table region unit on the basis of a look-up-table stored in the “Queue” block, the physical block and the reserved block in a volatile EEPROM region inside of the controller.

2. A data writing method in a high-capacity flash erasable and programmable read-only memory (EEPROM) card system mounted with at least one flash EEPROM and a controller connected to a host computer, having an interface for down/up loading arbitrary data into the flash EEPROM data regions to access the host computer, wherein the data writing operation method in the flash EEPROM system for setting a designated number of block regions that divide the flash EEPROM data regions into a designated arbitrary size and for sub-dividing each block region to a designated number of mapping table regions comprises:
a first procedure for transmitting CHS (Cylinder, Head, and Sector)value to let the host access data files in the flash EEPROM;
a second procedure for generating logical block address (LBA) on the basis of the transmitted CHS from the first procedure and for deciding whether or not the generated LBA's range exceeds full capacity of the flash EEPROM;
a third procedure for storing the data transmitted from the host in volatile memory inside of the controller and for converting the stored data to physical block address (PBA);
a fourth procedure for obtaining an index number of the mapping table region based on the PBA and for comparing the index number with a previous index number;
a fifth procedure for storing a current look-up-table in the flash EEPROM, if the new index number obtained in the fourth procedure is not identical with the previous index number, loading a look-up-table corresponding to the new index number from the flash EEPROM, and for changing the new index number back to the previous index number; and
a sixth procedure for obtaining a new PBA for use of the flash EEPROM from “Queue” block table of the volatile memory inside of the controller, writing data from a data buffer inside of the volatile memory on a corresponding mapping table region of a relevant flash EEPROM on the basis of the new PBA, and for updating the look-up-table.

3. A data reading method in a high-capacity flash erasable and programmable read-only memory (EEPROM) card system mounted with at least one flash EEPROM and a controller connected to a host computer, having an interface for down/up loading arbitrary data into the flash EEPROM data regions to access the host computer, wherein the data reading method in the flash EEPROM system for setting a designated number of block regions that divide the flash EEPROM data regions into a designated arbitrary size and for sub-dividing each block region to a designated number of mapping table region comprises:
a first procedure for transmitting CHS (Cylinder, Head, and Sector) value to let the host access data files in the flash EEPROM;
a second procedure for generating logical block address (LBA) on the basis of the transmitted CHS from the first procedure and for deciding whether or not the generated LBA's range exceeds full capacity of the flash EEPROM;
a third procedure for storing the data transmitted from the host in volatile memory inside of the controller and for converting the stored data to physical block address (PBA);
a fourth procedure for obtaining an index number of the mapping table region based on the PBA and for comparing the index number with a previous index number;
a fifth procedure for storing a current look-up-table in the flash EEPROM, if the new index number obtained in the fourth procedure is not identical with the previous index number, loading a look-up-table corresponding to the new index number from the flash EEPROM, and for changing the new index number back to the previous index number; and
a sixth procedure for transmitting data corresponding to the loaded look-up-table in the fifth procedure to the host side.
